(19) United States
(12) Patent Application Publication
(10) Pub. No.: US 2017/0326723 A1
(43) Pub. Date: Nov. 16, 2017

(54) TOOL HOLDER

(71) Applicant: Ying-Hsiang Chao, Taichung City (TW)

(72) Inventor: Ying-Hsiang Chao, Taichung City (TW)

(21) Appl. No.: 15/154,390

(22) Filed: May 13, 2016

(51) Int. Cl. B25H 3/00

(52) U.S. Cl. CPC B25H 3/006

(57) ABSTRACT

A tool holder includes a ring, a magnet and a shell. The ring is formed with a first end, a second end and an internal flange at the first end. The magnet is located in the ring and restrained by the internal flange. The shell covers the ring and the magnet. The shell includes claws for catching the ring to keep magnet in the ring and the ring in the shell.

### BACKGROUND OF INVENTION

### 1. Field of Invention

The present invention relates to tools and, more particularly, to a tool holder.

### 2. Related Prior Art

As disclosed in Taiwanese Patent M428035, a conventional tool holder includes an elongated element 10, blocks 20, rods 23, a strip 40 and thumbtack-shaped elements 50. The blocks 20 are attached to the elongated element 10. The rods 23 axially extend from some of the blocks 20. The strip 40 is provided on the rods 23 after sockets 30 are fitted on the blocks 20. Finally, the thumbtack-shaped elements 50 are engaged with the rods 23 to retain the sockets 30 on the blocks 20, between the elongated element 10 and the strip 40. However, this conventional tool holder holds only a fixed number of tools. Several tool holders must be used when there are more sockets than one tool holder can hold. However, the tool holders cannot be bonded for neatly or conveniently.

As disclosed in Taiwanese Patent M483157, another conventional tool holder system includes several tool holders. Each of the tool holders includes a plate 10, an opening 12 in the plate 10, dovetails 111 formed on an edge of the plate 10, dovetail recesses 112 in an opposite edge of the plate 10, and blocks 113 formed on a front face 11 of the plate 10. Sockets can be fitted on the blocks 113. The dovetails 111 of one tool holder can be fitted in the dovetail recesses of another tool holder to bond the tool holders. The tool holders are supported on a wall or net by nails, rods or claws. However, it is difficult to locate the nails, rods or claws corresponding to the openings of the tool holders when the nails or rods are attached to the wall beforehand or the width of each eye of the net are not identical to the width of each tool holder.

The present invention is therefore intended to obviate or at least alleviate the problems encountered in prior art.

### SUMMARY OF INVENTION

It is the primary objective of the present invention to provide a convenient tool holder.

To achieve the foregoing objectives, the tool holder includes a ring, a magnet and a shell. The ring is formed with a first end, a second end and an internal flange at the first end. The magnet is located in the ring and restrained by the internal flange. The shell covers the ring and the magnet. The shell includes claws for catching the ring to keep magnet in the ring and the ring in the shell.

Other objectives, advantages and features of the present invention will become apparent from the following description referring to the attached drawings.

### BRIEF DESCRIPTION OF DRAWINGS

The present invention will be described via detailed illustration of six embodiments referring to the drawings wherein:

FIG. 1 is an exploded view of a tool holder according to the first embodiment of the present invention;

FIG. 2 is a cross-sectional view of a magnet and a ring of the tool holder shown in FIG. 1;

FIG. 3 is a perspective view of the tool holder shown in FIG. 1;

FIG. 4 is a cross-sectional view of the tool holder shown in FIG. 3;

FIG. 5 is a front view of two tool holders as shown in FIG. 1;

FIG. 6 is a cross-sectional view of a magnet and a ring of a tool holder according to the second embodiment of the present invention;

FIG. 7 is a cross-sectional view of a tool holder including the magnet and the ring shown in FIG. 1;

FIG. 8 is an exploded view of a tool holder according to the third embodiment of the present invention;

FIG. 9 is a perspective view of a tool held on the tool holder shown in FIG. 8;

FIG. 10 is a perspective view of a tool holder according to the fourth embodiment of the present invention;

FIG. 11 is a perspective view of a tool holder according to the fifth embodiment of the present invention; and

FIG. 12 is a perspective view of a tool holder according to the sixth embodiment of the present invention.

### DETAILED DESCRIPTION OF EMBODIMENTS

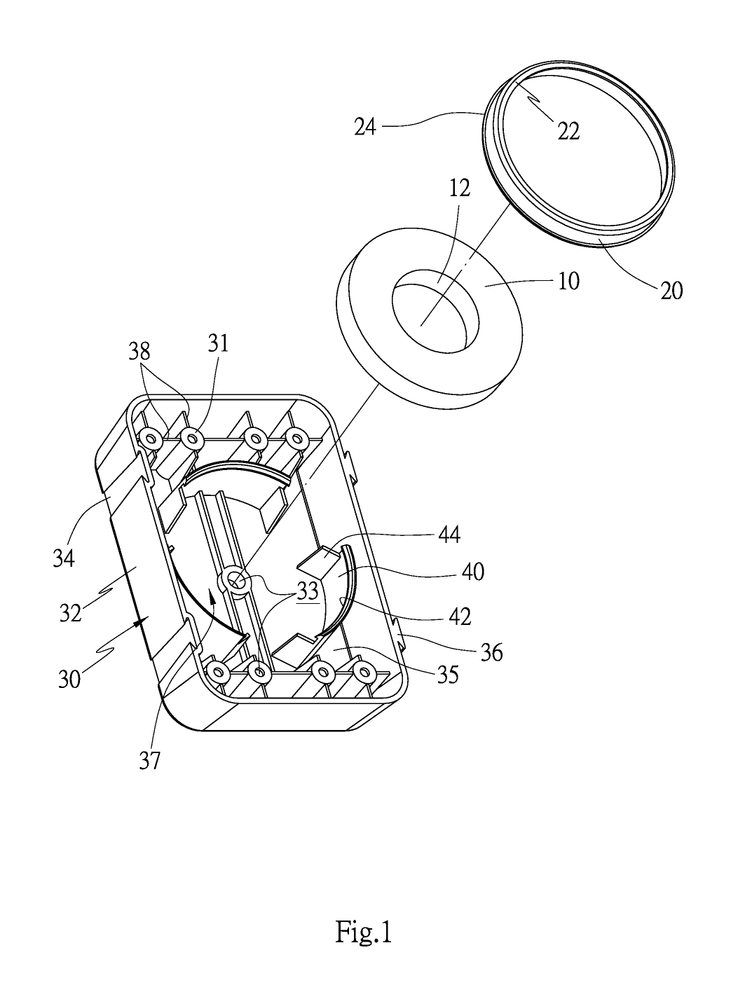

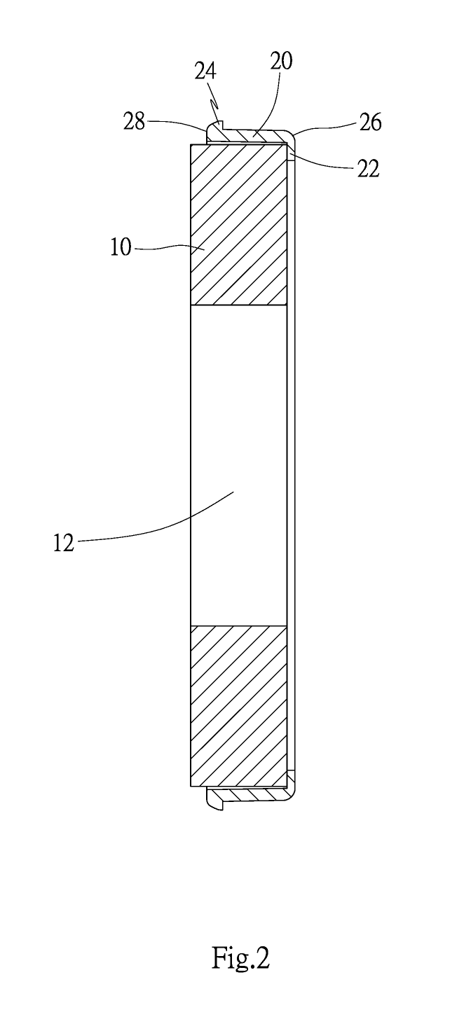

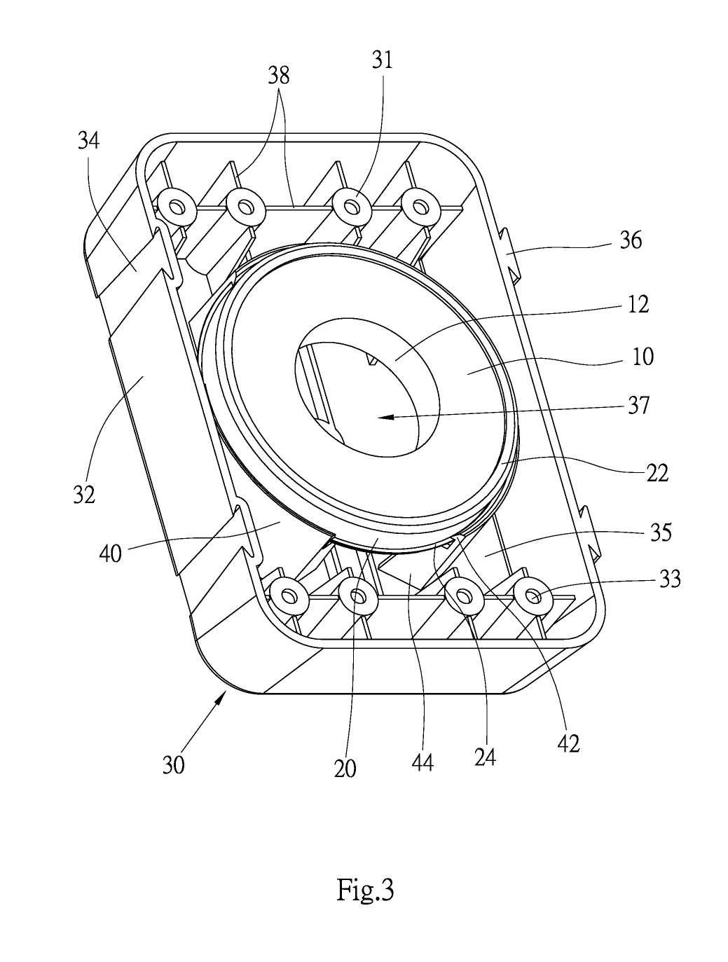

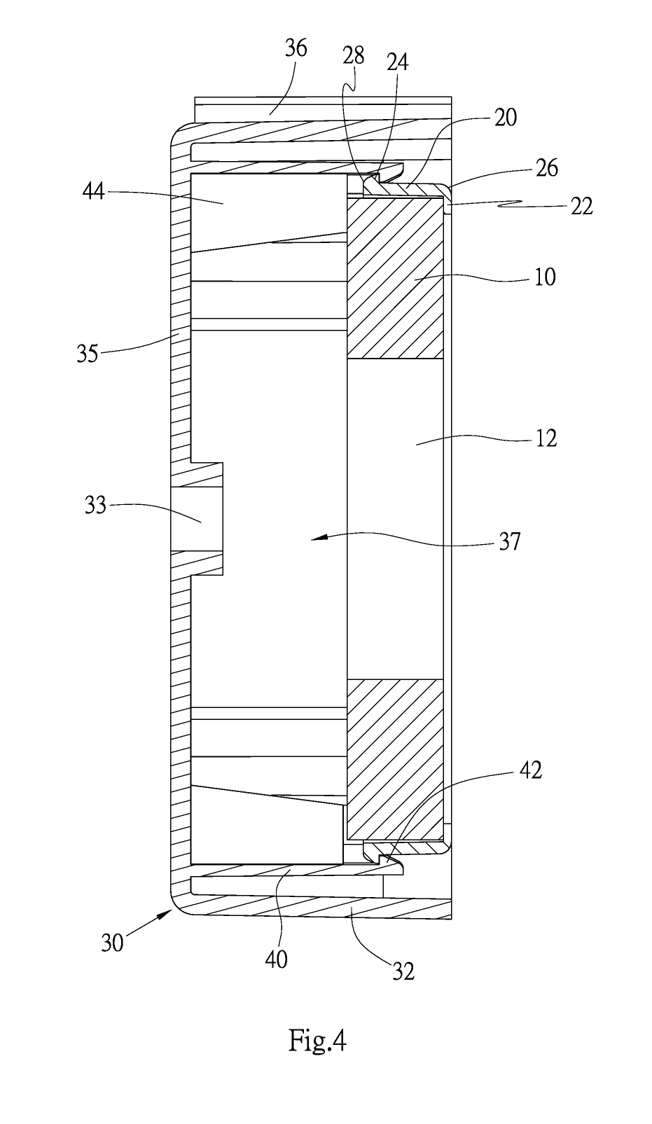

Referring to FIGS. 1 through 4, a tool holder includes a magnet 10, a ring 20 and a shell 30 according to a first embodiment of the present invention. The magnet 10 is an annular permanent magnet made with a circular central aperture 12.

The ring 20 is shaped corresponding to the magnet 10. The ring 20 is made with two ends 26 and 28 axially. An internal flange 22 is formed on an internal face of the ring 20, near the first end 26. The internal flange 22 extends perpendicular to the ring 20. An external flange 24 is formed on an external face of the ring 20, near the second end 28. The external flange 24 extends perpendicular to the ring 20.

The ring 20, the internal flange 22 and the external flange 24 are made in one piece of metal. Hence, the magnet 10 magnetically attracts the ring 20 or the internal flange 22 when the magnet 10 is inserted in the ring 20. However, the ring 20, the internal flange 22 and the external flange 24 can be made in one piece of non-metal material such as plastics in another embodiment.

The shell 30 includes a wall 32 continuously extending around a rectangular panel 35, near a rear face. The wall 32 and the panel 35 are made in one piece of plastics. The wall 32 is made with dovetail grooves 34 in a side and dovetails 36 on an opposite side. The dovetail grooves 34 are shaped in compliance with the dovetails 36. The panel includes recesses 33. One of the recesses 33 is located in the center of the panel 35. The dovetails groove 34 can be replaced with recesses in any other proper shape while the dovetails 36 can be replaced with corresponding protrusions in another embodiment.

Cylinders 31, ribs 38 and claws 40 extend from the rear face of the panel 35. The cylinders 31, the ribs 38, the claws 40 and the shell 30 are made in one piece. The cylinders 31, the ribs 38 and the claws 40 are surrounded by the wall 32. Each of the cylinders 31 is aligned with a corresponding one of the recesses 33. The cylinders 31 are reinforced by the ribs 38. There is a space 37 surrounded by the claws 40. Each of the claws 40 is an arched element formed with two ribs 44 at two ends. The ribs 44 extend from the rear face of the shell 30 shorter than the claws 40.

The ring 20 and the magnet 10 are inserted in the space 37 so that they are surrounded by the claws 40. The ribs 44 abut against the magnet 10 and the ring 20 so that the second end 28 of the ring 20 does not sink too deep into the space 37. The barbs 42 of the claws 40 are engaged with the external flange 24 to keep the ring 20 in the shell 30. The magnet 10 is restrained between the ribs 44 and the internal flange 22, i.e., the magnet 10 is kept in position. The central aperture 12 of the magnet 10 is aligned with the central recess 33 of the panel 35 hence do not interfere with anything inserted in the recesses 33.

The magnet 10 magnetically attracts a ferromagnetic element such as a door or a board. Thus, the pen holder can be located in any desired position on the ferromagnetic element. The pen holder can easily be detached from the ferromagnetic element.

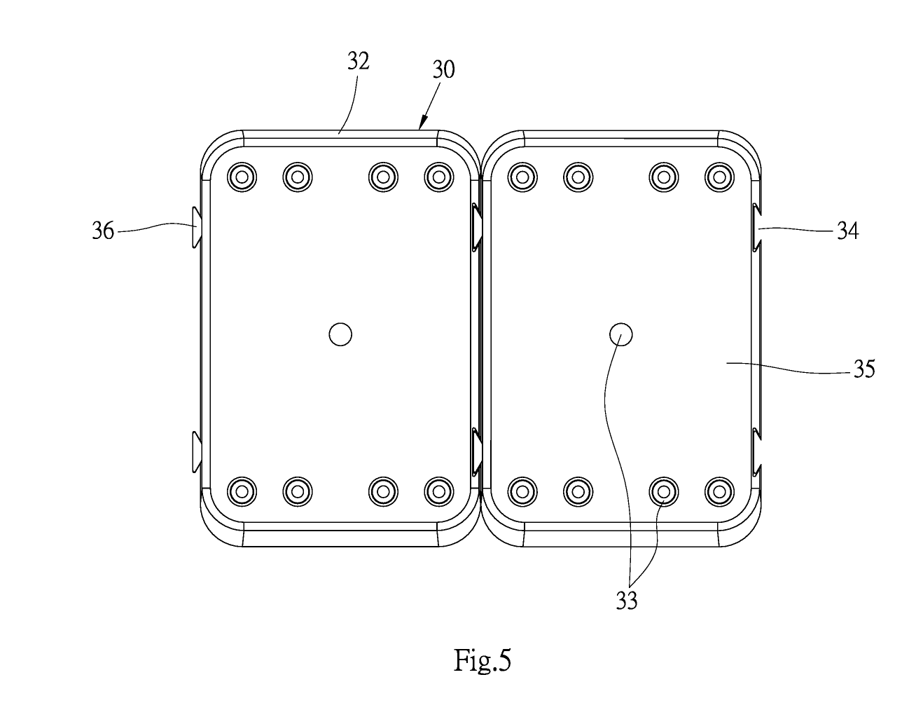

Referring to FIG. 5, there are two tool holders. The dovetails 36 of one of the tool holders are inserted in the dovetail grooves 34 of the other tool holder. Thus, the tool holders are bonded neatly without occupying much space. Similarly, more tool holders can be bonded.

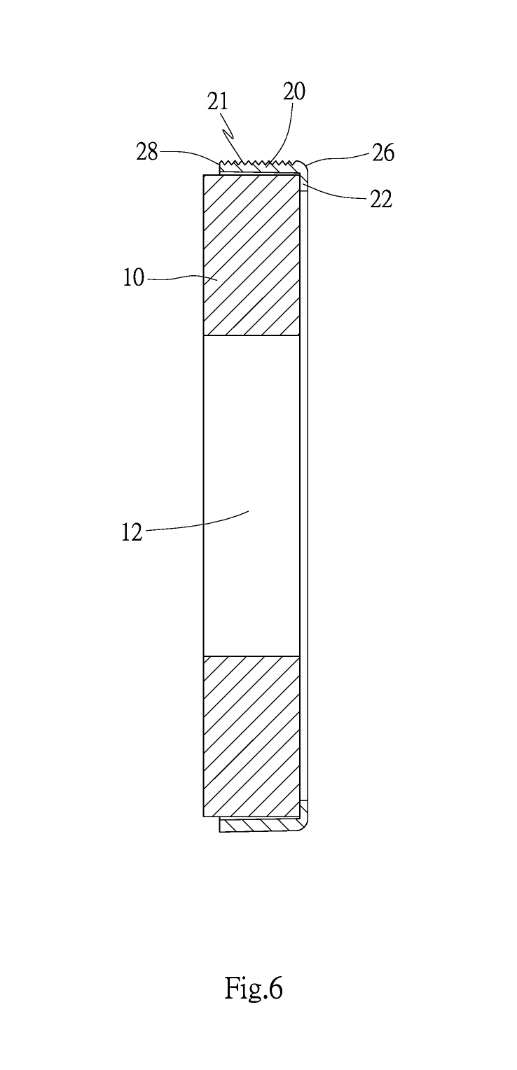

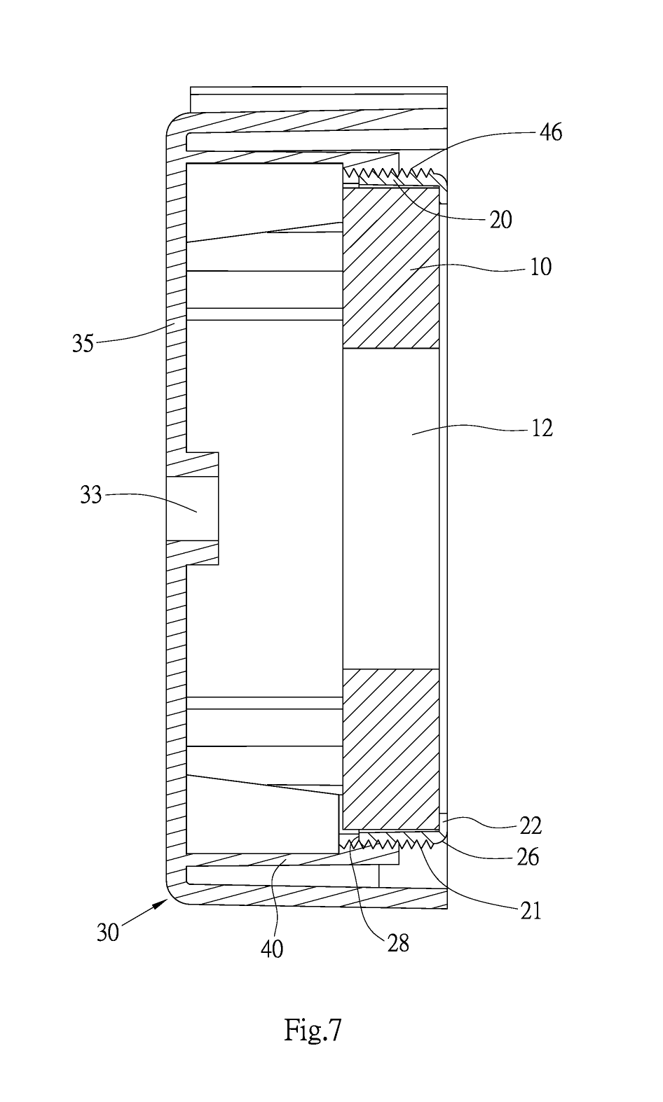

Referring to FIGS. 6 and 7, there is a tool holder according to a second embodiment of the present invention. The second embodiment is identical to the first embodiment except for two features. Firstly, the ring 20 includes a thread 21 instead of the external flange 24. Secondly, the claws 40 include threads 46 instead of barbs 42. The thread 21 is engaged with the threads 46 to attach the ring 20 to the claws 40 and hence to the shell 30.

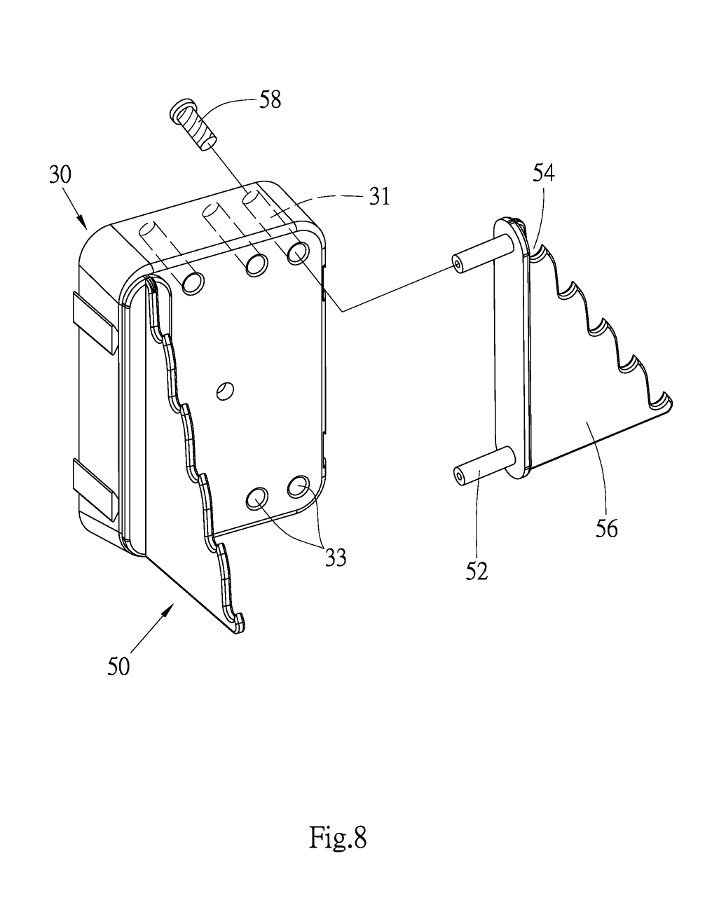

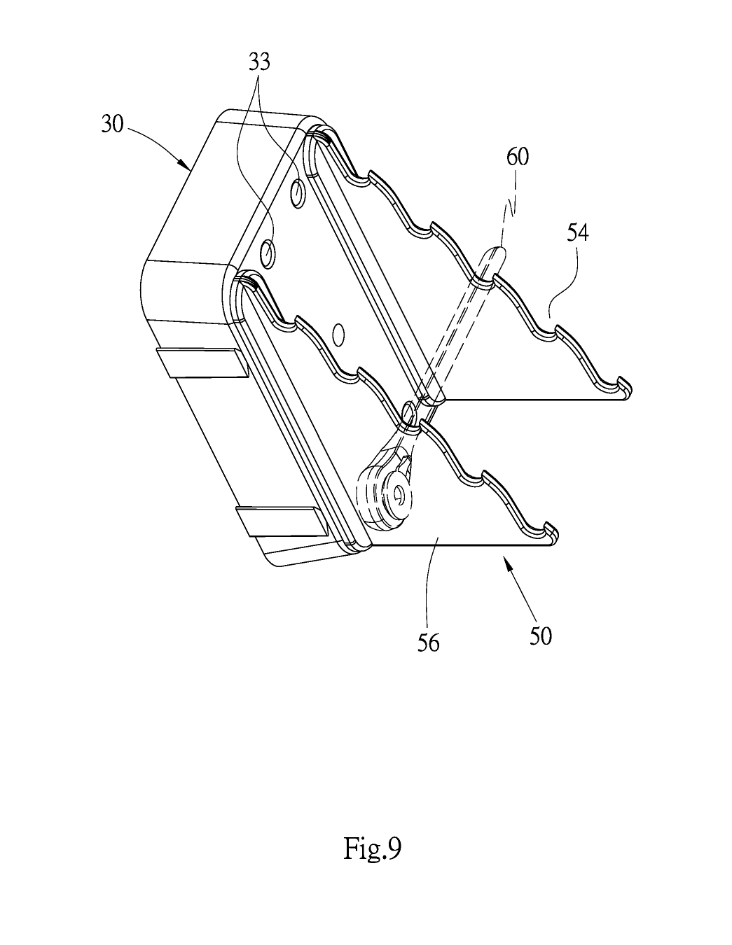

Referring to FIGS. 8 and 9, there is a tool holder according to a third embodiment of the present invention. The third embodiment is identical to the first embodiment except for including two tool supports 50 in addition. Each of the tool supports 50 includes a board (not numbered), a substantially triangular fin 56 extending from a front face of the board, and two roots 52 extending from a rear face of the board. The fin 56 of each of the tool supports 50 is formed with cutouts 54. In use, each of the roots 52 is inserted in one of the recesses 33 to attach the tool supports 56 to the shell 30. Screws 58 can be inserted in the roots 52 through the cylinders 31 to firmly keep the tool supports 50 on the shell if necessary. A tool 60 can easily and stably be supported on the tool supports 50 by inserting a portion of the tool 60 in one of the cutouts 54 of one of the tool supports 50 and another portion of the tool 60 in one of the cutouts 54 of the other tool support 50.

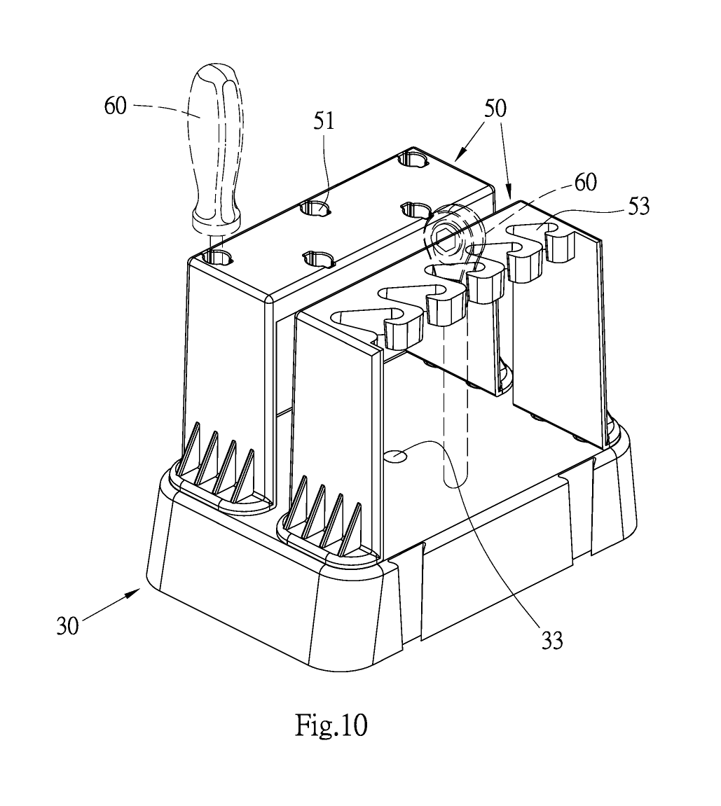

Referring to FIG. 10, there is a tool holder according to a fourth embodiment of the present invention. The third embodiment is identical to the third embodiment except including two different tool supports 50. Each of the tool supports 50 includes two lateral plates extending from a middle plate. Roots 52 extend from a lower end of each of the lateral plates. The middle plate of one of the tool supports 50 is made with apertures 51. Cutouts 53 are made in an edge of the middle plate of the other tool support 50. A tool 60 can be inserted one of the cutouts 53 or apertures 51.

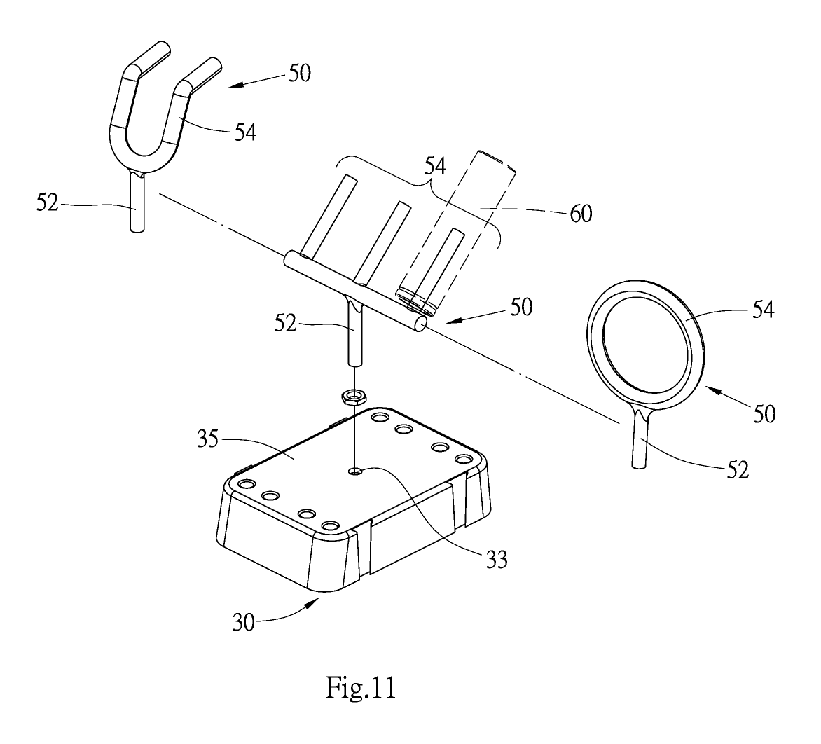

Referring to FIG. 11, there is a tool holder according to a fifth embodiment of the present invention. The fifth embodiment is identical to third embodiment except including three different tool supports 50. One of the tool supports 50 includes three prongs 54 and a root 52. A tool 60 such as socket can be supported on one of the prongs 54. Another tool support 50 includes two prongs 54 and a root 52. The other tool support 50 includes a ring 54 and a root 52.

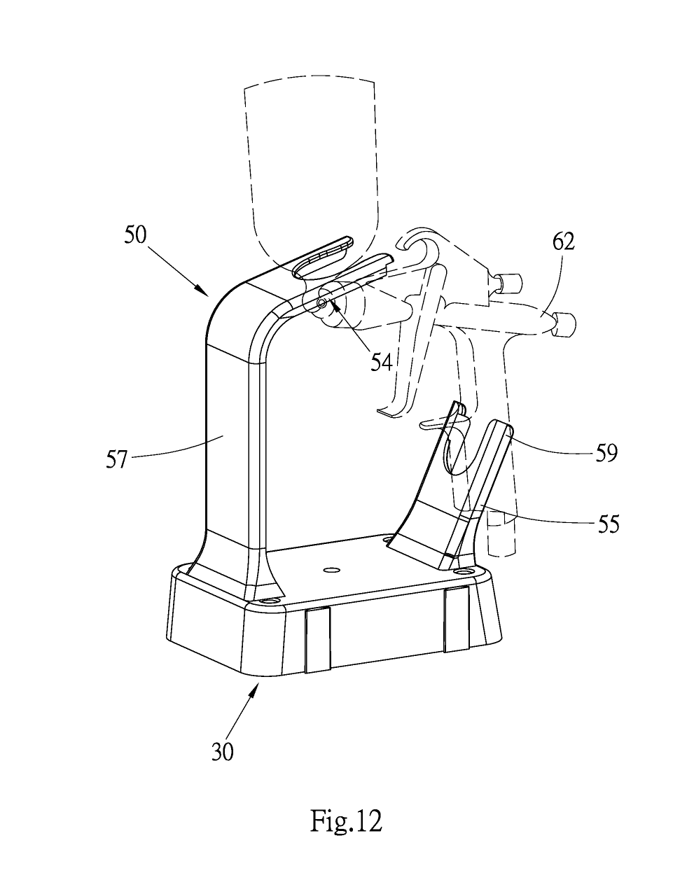

Referring to FIG. 12, there is a tool holder according to a sixth embodiment of the present invention. The sixth embodiment is like the third embodiment except including two different tool supports 50. One of the tool supports 50 is a bent element including a relatively short flat body 55 while the other tool support 50 is a rectilinear element including a relatively long flat body 57. Each of the tool supports 50 includes a cutout 54 made between two prongs 59 extending from an upper end thereof. The cutout 54 of one of the tool supports 50 receives a portion of a sprayer gun 62 while the cutout 54 of the other tool support 50 receives another portion of the sprayer gun 62.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A tool holder comprising:
a ring formed with a first end, a second end and an internal flange at the first end;
a magnet located in the ring and restrained by the internal flange;
a shell for covering the ring and the magnet, wherein the shell comprises claws for catching the ring to keep magnet in the ring and the ring in the shell.

2. A tool holder according to claim 1, wherein the ring comprises an external flange at the second end, wherein each of the claws comprises a barb for engagement with the external flange of the ring.

3. A tool holder according to claim 1, wherein the ring comprises a thread, wherein each of the claws comprises threads engaged with the thread of the ring.

4. A tool holder according to claim 1, wherein the shell further comprises dovetail grooves and dovetails, wherein the dovetails can be inserted in the dovetail grooves of another tool holder to bond the tool holders.

5. A tool holder according to claim 1, wherein the claws surround a space for receiving the ring.

6. A tool holder according to claim 5, wherein each of the claws is formed with two ribs for abutment against the ring to keep the ring in a proper depth in the space.

7. A tool holder according to claim 1, wherein the shell comprises a panel and a wall extending around the panel.

8. A tool holder according to claim 7, further comprising at least one tool support attached to the panel and adapted for supporting a tool.

9. A tool holder according to claim 8, wherein the shell further comprises recesses, wherein the tool support comprises a root inserted in one of the recesses.

10. A tool holder according to claim 9, wherein the shell further comprises cylinders formed on a rear face of the panel and adapted for receiving screws, wherein some of the recesses are in communication with the cylinders.

11. A tool holder according to claim 10, wherein the shell further comprises ribs connected to the cylinders.
